(19) United States
(12) Patent Application Publication
(10) Pub. No.: US 2026/0131173 A1
(43) Pub. Date: May 14, 2026

(54) SYSTEM AND METHOD OF A RING ARCHITECTURE OF A FIXED PIPING SYSTEM IMPLEMENTED WITHIN A SAFETY SYSTEM OF A STRUCTURE TO CONTINUOUSLY SUPPLY BREATHABLE AIR THEREWITHIN

(71) Applicant: Rescue Air Systems, Inc., San Carlos, CA (US)

(72) Inventor: Anthony J. Turiello, Redwood City, CA (US)

(73) Assignee: Rescue Air Systems, Inc., San Carlos, CA (US)

(21) Appl. No.: 19/437,559

(22) Filed: Dec. 31, 2025

Related U.S. Application Data
(63) Continuation of application No. 18/106,483, filed on Feb. 7, 2023, now Pat. No. 12,544,601.
Application No. 18/106,483 is a continuation-in-part of application No. 18/103,495, filed on Jan. 31, 2023, now Pat. No. 12,553,626.
(60) Provisional application No. 63/356,996, filed on Jun. 29, 2022.
(60) Provisional application No. 63/356,996, filed on Jun. 29, 2022.
(60) Provisional application No. 63/357,743, filed on Jul. 1, 2022.
(60) Provisional application No. 63/357,743, filed on Jul. 1, 2022.
(60) Provisional application No. 63/358,876, filed on Jul. 7, 2022.
(60) Provisional application No. 63/388,650, filed on Jul. 13, 2022.

(51) Int. Cl. A62B 15/00; F24F 3/00; F24F 7/04; F24F 11/35; F24F 13/02; F24F 120/20

(52) U.S. Cl. CPC A62B 15/00; F24F 3/00; F24F 7/04; F24F 11/35; F24F 13/0227; F24F 2120/20

(57) ABSTRACT

A safety system implemented within a structure includes a source of breathable air, and a fixed piping system to supply the breathable air from the source to each interior region of a number of interior regions across the structure. The fixed piping system is implemented in a ringed architecture including a first portion of the fixed piping system proximate the each interior region and a second portion thereof farther away from the each interior region. In accordance with the ringed architecture, the first portion and the second portion are implemented as a continuous ring with respect to the source of the breathable air such that, even during a compromise of a first sub-portion of the first portion, unaffected by the compromise, the breathable air continues to be supplied to a second sub-portion of the first portion by way of the second portion.

### CROSS-REFERENCE TO RELATED APPLICATIONS

The present application is a continuation of U.S. patent application Ser. No. 18/106,483, filed Feb. 7, 2023, which claims the benefit of and priority to U.S. Provisional Application Nos. 63/356,996, filed Jun. 29, 2022, 63/357,743, filed Jul. 1, 2022, and 63/388,650, filed Jul. 13, 2022, and which is a continuation in part of U.S. patent application Ser. No. 18/103,495, filed Jan. 31, 2023, which claims the benefit of and priority to U.S. Provisional Application Nos. 63/356,996, filed Jun. 29, 2022, 63/357,743, filed Jul. 1, 2022, and 63/358,876, filed Jul. 7, 2022, the disclosures of each of which are incorporated herein by reference in their entireties.

### FIELD OF TECHNOLOGY

This disclosure generally relates to emergency systems and, more particularly, to systems and/or a method of a ring architecture of a fixed piping system implemented within a safety system of a structure to continuously supply breathable air therewithin.

### BACKGROUND

According to the National Fire Protection Association (NFPA), most fire deaths result from smoke inhalation rather than burns. Smoke inhalation may provide for a disorientation of a human being so quick that there is little time to access clean, breathable air prior thereto. In an extended structure such as a warehouse, a shopping mall, a hypermart and an industrial structure, a region thereof compromised due to an event such as a fire incident may cause a piping system implemented as part of a supply of breathable air to emergency personnel to be compromised at not only the same region but also one or more region(s) adjacent thereto. The compromise may also be due to the smoke pervading the compromised region(s) and/or other air related risks and possibilities. In order to mitigate the effects of the aforementioned compromise, the breathable air flow through the piping system may have to be shut down.

### SUMMARY

Disclosed are systems and/or a method of a ring architecture of a fixed piping system implemented within a safety system of a structure to continuously supply breathable air therewithin.

In one aspect, a safety system implemented within a structure includes a source of breathable air, and a fixed piping system to supply the breathable air from the source to each interior region of a number of interior regions across the structure. The fixed piping system is implemented in a ringed architecture including a first portion of the fixed piping system proximate the each interior region of the number of interior regions and a second portion of the fixed piping system farther away from the each interior region of the number of interior regions. In accordance with the ringed architecture, the first portion and the second portion are implemented as a continuous ring with respect to the source of the breathable air such that, even during a compromise of a first sub-portion of the first portion of the fixed piping system relevant to one or more interior region(s) of the number of interior regions proximate thereto, unaffected by the compromise, the breathable air continues to be supplied to a second sub-portion of the first portion of the fixed piping system by way of the second portion of the fixed piping system.

In another aspect, a safety system implemented within a structure includes a source of breathable air, and a fixed piping system to supply the breathable air from the source to each interior region of a number of interior regions of the structure. The fixed piping system is implemented in a ringed architecture including a first portion of the fixed piping system proximate the each interior region of the number of interior regions and a second portion of the fixed piping system farther away from the each interior region of the number of interior regions. In accordance with the ringed architecture, the first portion and the second portion are implemented as a continuous ring with respect to the source of the breathable air such that, even during a compromise of a first sub-portion of the first portion of the fixed piping system relevant to one or more interior region(s) of the number of interior regions proximate thereto, unaffected by the compromise, the breathable air continues to be supplied to a second sub-portion of the first portion of the fixed piping system by way of the second portion of the fixed piping system. The safety system also includes a hardware controller to detect an event related to the compromise solely or in conjunction with a data processing device communicatively coupled thereto.

In yet another aspect, a method of a safety system implemented within a structure includes supplying breathable air from a source to each interior region of a number of interior regions of the structure through a fixed piping system, and implementing the fixed piping system in a ringed architecture including a first portion of the fixed piping system proximate the each interior region of the number of interior regions and a second portion of the fixed piping system farther away from the each interior region of the number of interior regions. The method also includes, in accordance with the ringed architecture, forming a continuous ring involving both the first portion and the second portion with respect to the source of the breathable air such that, even during a compromise of a first sub-portion of the first portion of the fixed piping system relevant to one or more interior region(s) of the number of interior regions proximate thereto, unaffected by the compromise, the breathable air continues to be supplied to a second sub-portion of the first portion of the fixed piping system by way of the second portion of the fixed piping system.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a safety system implemented within a structure, according to one or more embodiments.

FIG. 2 is a schematic view of an example implementation of a control panel of the safety system of FIG. 1.

FIG. 3 is a schematic view of a context in which the safety system of FIG. 1 operates, according to one or more embodiments.

FIG. 4A is an example user interface view of a data processing device of the safety system of FIG. 1.

FIG. 4B is another example user interface view of the data processing device of the safety system of FIG. 1.

FIG. 5 is a schematic view of a hardware controller compatible with the safety system of FIG. 1, according to one or more embodiments.

FIG. 6 is a schematic view of a mesh configuration of a fixed piping system of the safety system of FIG. 1 and FIG. 3 with a shell ring, according to one or more embodiments.

FIG. 7 shows a process flow diagram detailing the operations involved in a safety system implemented with a ringed air piping architecture of a fixed piping system within a structure to continuously supply breathable air therewithin, according to one or more embodiments.

Other features of the present embodiments will be apparent from the accompanying drawings and from the detailed description that follows.

### DETAILED DESCRIPTION

Example embodiments, as described below, may be used to provide systems and/or a method of a ring architecture of a fixed piping system implemented within a safety system of a structure to continuously supply breathable air therewithin. Although the present embodiments have been described with reference to specific example embodiments, it will be evident that various modifications and changes may be made to these embodiments without departing from the broader spirit and scope of the various embodiments.

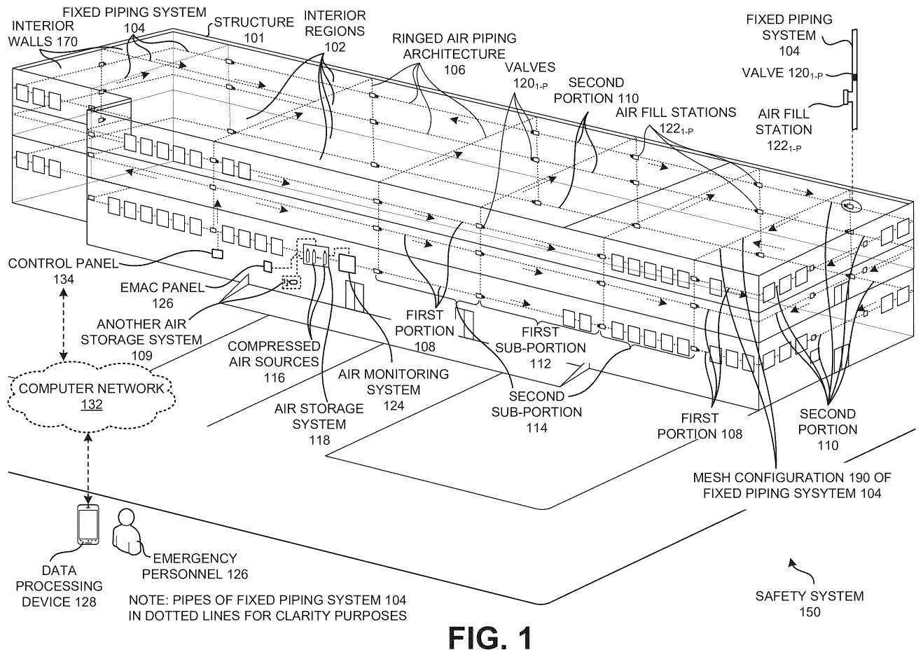

FIG. 1 shows a safety system 150 implementing a ringed air piping architecture 106 of a fixed piping system 104 within a structure 101, according to one or more embodiments. In one or more embodiments, structure 101 may be a shopping mall, a hypermart, an extended shopping facility, a storage and/or a warehousing-related structure (e.g., a storage center, a fulfilment center), a tunnel, a marine craft (e.g., a large marine vessel such as a cruise ship, a cargo ship, a submarine and/or a large naval craft, which may be a “floating” version of a building and/or a horizontal structure) and/or a mine. Other types of structure 101 are within the scope of the exemplary embodiments discussed herein. In one or more embodiments, structure 101 may include a storage and/or a production area divided into a number of interior regions 102, which may include a number of bays and/or parts of structure 101 interconnected by passageways (e.g., aisles) to allow easy mobility therewithin.

In one or more embodiments, fixed piping system 104 of safety system 150 may include permanent air conduits installed within structure 101 serving as a constant source of replenishment of breathable air. In one or more embodiments, fixed piping system 104 may be regarded as being analogous to a water piping system within structure 101 or another structure analogous thereto for the sake of imaginative convenience. In one or more embodiments, ringed air piping architecture 106 of fixed piping system 104 may include pipes (e.g., constituted out of stainless steel tubing) that distribute breathable air to a number of air fill stations 122_{1-P} within structure 101.

In one or more embodiments, safety system 150 may be a Firefighter Air Replenishment System (FARS) associated with structure 101. In one or more embodiments, safety system 150 may enable firefighters entering structure 101 in times of fire-related emergencies to gain access to breathable (e.g., human breathable) air within structure 101 without the need of bringing in additional air bottles/cylinders deep thereinto, or to refill depleted air bottles/cylinders that are brought into structure 101. In one or more embodiments, safety system 150 may include one or more compressed air source(s) 116 (e.g., air tanks) in an air storage system 118 to supply breathable air to each interior region 102 (e.g., bay) of structure 101.

In one or more embodiments, fixed piping system 104 may include a number of linked/interlinked air pipe segments (e.g., a first sub-portion 112, a second sub-portion 112, etc.; to be discussed below) running across the number of interior regions 102 (e.g., bays) of structure 101 and forming a continuous ringed architecture (e.g., ringed air piping architecture 106) to supply breathable air. In one or more embodiments, ends of each linked air pipe segment (e.g., first sub-portion 112) of fixed piping system 104 may be interconnected with adjacent linked air pipe segments (e.g., second sub-portion 114, etc.) thereof. As shown in FIG. 1, in one or more embodiments, a first portion 108 of fixed piping system 104 may refer to the portion of fixed piping system 104 on a side proximate a specific interior region 102 in FIG. 1, and a second portion 110 of fixed piping system 104 may refer to a side farther away from the specific interior region 102 of FIG. 1. In one or more embodiments, each of first portion 108 and second portion 110 of fixed piping system 104 (and fixed piping system 104) may be provided along one or more (or, a number of) interior walls 170 of structure 101, as shown in FIG. 1. In general, in one or more embodiments, fixed piping system 104 may be provided within a fire-rated enclosure (e.g., interior walls 170) of structure 100.

In one or more embodiments, the continuous ring/ring architecture formed by the linked air pipe segments and the linked first portion 108 and the second portion 110 may enable multidirectional flow of breathable air through ringed air piping architecture 106; in one or more embodiments, this may also build redundancy into safety system 150, as will be seen below. In one or more embodiments, each interior region 102 may include an air fill station 122_{1-P} coupled to fixed piping system 104 to provide a sufficient supply of breathable air. In one or more embodiments, each segment of fixed piping system 104 may be isolated and/or disconnected from compressed air sources 116/air storage system 118 through operation of a valve 120_{1-P} (e.g., an isolation valve) located adjacent to air fill station 122_{1-P}. As discussed above, in one or more embodiments, structure 101 may be divided into a number of parts (e.g., the number of interior regions 102) for storage, production, and/or manufacturing of commodities. In one or more embodiments, structure 101 may implement a racking system based on optimization of space/area therewithin that is constituted by the number of interior regions 102.

In one or more embodiments, valves 120_{1-P} located at interior regions 102 may be operable to isolate a particular air fill station 122_{1-P} through a control panel 134 located in structure 101 in case of a maintenance requirement and/or an emergency situation such as a fire, an accident, an explosion, a leak, a chemical attack, etc. Also, in one or more embodiments, control panel 134 may control operation of valves 120_{1-P} to isolate and/or disconnect a particular air fill station 122_{1-P} for maintenance and/or emergency situations including but not limited to air leakage, a pipe/pipe segment burst and/or failure. In one or more embodiments, control panel 134 (an example hardware controller) may be communicatively coupled to one or more data processing device(s) (e.g., data processing device 128 such as a mobile phone; other forms of data processing device 128 are within the scope of the exemplary embodiments discussed herein) through a computer network 132 (e.g., a Local Area Network (LAN), a Wide Area Network (WAN), a short-range network, a cloud computing network and/or a distributed computing network). Thus, in one or more embodiments, event detection associated with a compromise within fixed piping system 104 may be possible through both control panel 134 and data processing device 128.

As shown in FIG. 1, in one or more embodiments, ringed air piping architecture 106 of fixed piping system 104 may distribute air from air storage system 118 including a number of compressed air sources 116 (e.g., air storage tanks) and/or another air storage system 109 (e.g., also including one or more compressed air source(s) (not shown)) that serve as sources of pressurized air. Additionally, in one or more embodiments, ringed air piping architecture 106 of fixed piping system 104 may interconnect with a mobile air unit (e.g., a fire vehicle) through an External Mobile Air Connection (EMAC) panel 126. In one or more embodiments, EMAC panel 126 may be a boxed structure (e.g., exterior to structure 101) to enable the interconnection between mobile air unit and safety system 150. For example, mobile air unit may include an on-board air compressor to store and replenish pressurized and/or compressed air in air bottles/cylinders (e.g., utilizable with Self-Contained Breathing Apparatuses (SCBAs) carried by firefighters).

In one or more embodiments, an air monitoring system 124 may be installed as part of safety system 150 to automatically track and monitor a parameter (e.g., pressure) and/or a quality (e.g., indicated by a moisture level, a carbon monoxide level) of breathable air within safety system 150. FIG. 1 shows air monitoring system 124 as communicatively coupled to air storage system 118 and EMAC panel 126 merely for the sake of example. It should be noted that EMAC panel 126 may be at a remote location associated with (e.g., internal to, external to) structure 101. In one or more embodiments, for monitoring the parameters and/or the quality of breathable air within safety system 150, air monitoring system 124 include appropriate sensors and circuitries therein. For example, a pressure sensor within air monitoring system 124 may automatically sense and record the pressure of the breathable air within safety system 150. Said pressure sensor may communicate with an alarm system that is triggered when the sensed pressure is outside a safe range. Also, in one or more embodiments, air monitoring system 124 may automatically trigger a shutdown of breathable air distribution through safety system 150 in case of impurity/contaminant (e.g., carbon monoxide) detection therethrough yielding levels above a safety threshold. In certain embodiments, air monitoring system 124 may be the same as control panel 134.

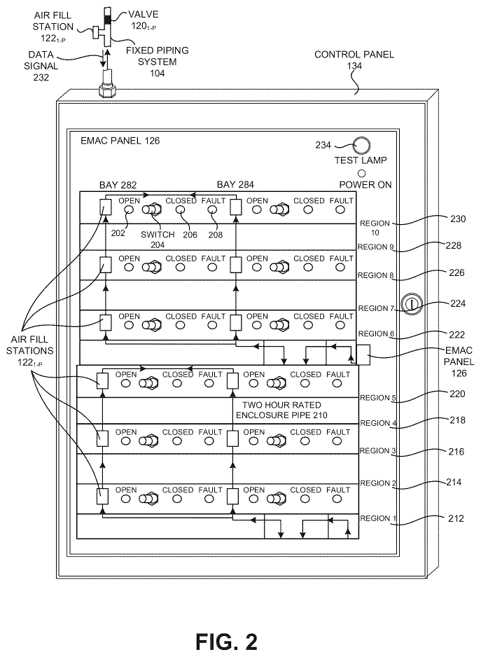

FIG. 2 shows control panel 134 of safety system 150, according to one or more embodiments. In one or more embodiments, control panel 134 may be a set of components working together to automatically switch ON/OFF valves 120_{1-P} and/or bypass particular air fill stations 122_{1-P} when a fault (e.g., leakage, breakdown, etc.) and/or an error is detected in ringed air piping architecture 106 of fixed piping system 104. In one or more embodiments, control panel 134 may be operated by authorized personnel (e.g., emergency personnel 126 of FIG. 1); also, as discussed above, data processing device 128 communicatively coupled to control panel 134 may automatically detect events associated with ringed air piping architecture 106 of fixed piping system 104.

It should be noted that the arrows indicating flow of breathable air may be one-sided or double-sided depending on the implementation of valves 120_{1-P}. For example, valves 120_{1-P} may be implemented with non-return/check valves, in which case the arrows may be unidirectional.

In one or more embodiments, control panel 134 may include an array of sensors (not shown) and circuitry to activate specific valves 120_{1-P} and/or to isolate specific air fill stations 122_{1-P} from a rest of safety system 150. As shown in FIG. 2, control panel 134 may indicate a bay 282 and a bay 284 (both bay 282 and bay 284 may be example interior regions 102), an open 202 indicator light, a closed 206 indicator light, a fault 208 indicator light, a switch 204, air fill station(s) 122_{1-P}, EMAC panel 126, interior regions 102 constituted by a region 212, a region 2 214, a region 3 216, a region 4 218, a region 5 220, a region 6 222, a region 7 224, a region 8 226, a region 9 228, a region 10 230, a two-hour rated enclosure piping 210, a data signal 232, and a lamp test 234, according to one example implementation.

In one or more embodiments, control panel 134 may indicate that both bay 282 and bay 284 are connected through ringed air piping architecture 106. The open 202 indicator light may be an illuminating device commonly used to signify (e.g., through blinking) that switch 204 (e.g., isolation switch) is in an OFF state. The OFF state of switch 204 may indicate that valve 120_{1-P} on that particular interior region 102 (e.g., region 1 212, region 2 214, region 3 216 etc.) is open, according to one implementation.

The closed 206 indicator light may be an illuminating device commonly used to signify (e.g., through blinking) that switch 204 is in an ON state. The ON state of switch 204 may indicate that valve 120_{1-P} is closed and a corresponding fill station 122_{1-P} is isolated, according to one implementation. This may be implemented even for control of multiple valves 120_{1-P} and multiple fill stations 122_{1-P}. As will be seen below, in one or more embodiments, the closure of an appropriate valve 120_{1-P} may cut off supply of breathable air to first sub-portion 112. The fault 208 indicator light may be an illuminating device commonly used to signify (e.g., through blinking) the occurrence of a faulty condition within fixed piping system 104/air fill station 122_{1-P} that requires immediate attention. In one or more example implementations, while actual statuses of valves 120_{1-P} may be reflected through, say, limit switches (not shown), control of switch 204 may control electrical coupling to open 202 indicator light, closed 206 indicator light and fault 208 indicator light. Thus, control of switch 204 may also be effected through electrical signals from said limit switches.

The switch 204 may be a device used to make or break a connection in a circuit so that emergency personnel 126 can operate (e.g., turn ON or OFF) valve 120_{1-P} to isolate one or more portions (e.g., first sub-portion 112) of fixed piping system 104 or a particular air fill station 122_{1-P}. When switch 204 of a particular interior region 102 (e.g., region 1 212, region 2 214, region 3 216 etc.) is in the open state, it may indicate that a corresponding valve 120_{1-P} associated with the particular interior region 102 is open. When the switch 204 of the particular interior region 102 is in the closed state, it may indicate that the corresponding valve 120_{1-P} associated with the particular interior region 102 is closed.

In one or more embodiments, control panel 134 may receive data signals (e.g., data signal 232) from various points (e.g., joints, junctions) of ringed air piping architecture 106 of fixed piping system 104 to enable detection of events associated therewith. In one or more embodiments, data signal 232 may be generated manually and/or automatically generated through sensors (not shown) in conjunction with control panel 134/data processing device 128. For example, operation of a switch 204 of a particular interior region 102 may make or break a connection with an associated valve 120_{1-P}. Said connection may also be made or broken automatically with an appropriate implementation of control panel 134 and/or data processing device 128.

Test lamp 234 may be an illuminating device used to determine that control panel 134 is powered. The two-hour rated enclosure piping 210 in control panel 134 may indicate that fixed piping system 104 is enclosed within a two-hour rated enclosure piping, which may protect fixed piping system 104 against a fire hazard for two hours. All of the aforementioned details are implementation specific and serve as mere example parameters. All variations in implementation of control panel 134 are within the scope of the exemplary embodiments discussed herein.

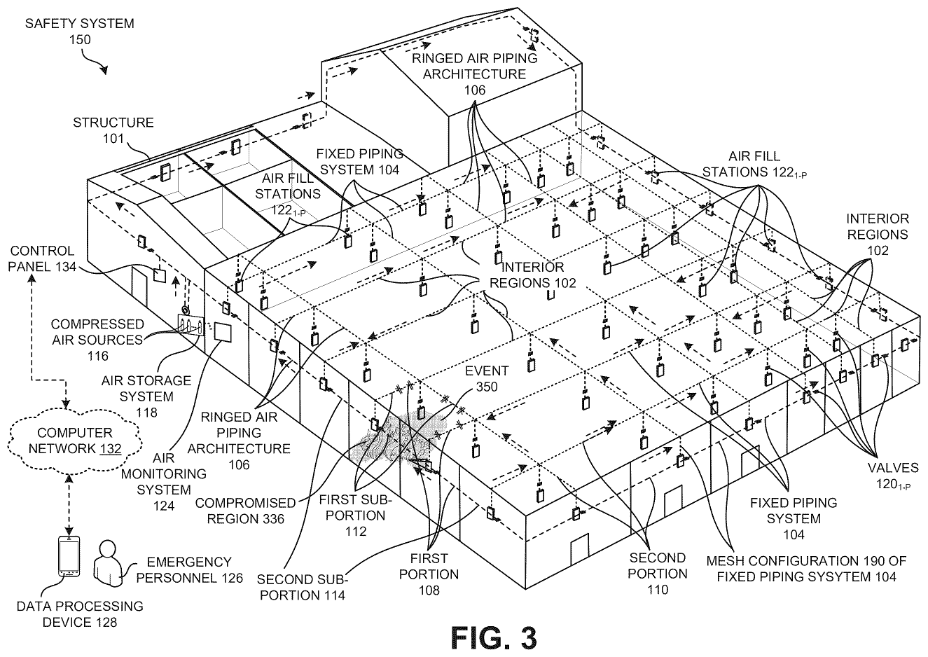

FIG. 3 shows a context in which safety system 150 of FIG. 1 operates, according to one or more embodiments. In one example scenario, an event 350 associated with a compromise of first sub-portion 112 of first portion 108 of ringed air piping architecture 106 of fixed piping system 104 at a particular interior region 102 (e.g., compromised region 336) may occur. Examples of event 350 may include but are not limited to a fire (as shown in FIG. 3), a piping fault, a piping leak, a poor quality of breathable air, contamination of breathable air within particular interior region 102 and a chemical leak. In one or more embodiments, event 350 (e.g., a fire) may be detected (e.g., based on sensor(s)/circuitry) through control panel 134 and/or data processing device 128 discussed above. In one or more embodiments, in accordance therewith, control panel 134 and/or data processing device 128 may cut off (e.g., automatically, manually) the breathable air to compromised region 336 encompassing/including first sub-portion 112 of first portion 108 based on controlling one or more valves 120_{1-P} associated with first sub-portion 112.

Now, in one or more embodiments, because safety system 150 has ringed air piping architecture 106 implemented therein, even during the compromise of first sub-portion 112 of first portion 108 relevant to one or more interior regions 102 (e.g., one bay, two bays) proximate thereto, unaffected by the compromise, the breathable air may continue to be supplied (e.g., through air storage system 118, another air storage system 109) to second sub-portion 114 of first portion 108 of fixed piping system 104 by way of second portion 110 of fixed piping system 104. In one or more embodiments, the interlinking and/or linking of pipe segments through ringed air piping architecture 106 may enable the aforementioned redundancy in breathable air supply to be implemented within safety system 150. It should be noted that certain components of safety system 150 of FIG. 1 have not been shown in FIG. 3 for the sake of illustrative clarity. However, it should be noted that all components of FIG. 1 are also relevant to FIG. 3 and vice versa.

The redundancy built into safety system 150 may enable emergency personnel 126 to work toward setting safety system 150 right as soon as possible with minimized difficulties during emergencies (e.g., event 350). In one or more embodiments, real-time communication between emergency personnel 126, a fire control room (not shown) within safety system 150 and a firefighting command center (not shown) may also be facilitated through computer network 132. In one or more embodiments, this may enable isolation of one or more air fill stations 122_{1-P} and closure of one or more valves 120_{1-P} associated with compromised region 336 (e.g., first sub-portion 112) from the rest of safety system 150. In one or more embodiments, emergency personnel 126 may still be able to receive a continuous supply of breathable air via fill stations 122_{1-P} associated with the non-isolated sub-portions (e.g., second sub-portion 114) of first portion 108 by way of second portion 110 of fixed piping system 104; for example, the non-isolated sub-portions of first portion 108 may be associated with interior regions 102 adjacent to an interior region 102 associated with compromised region 336.

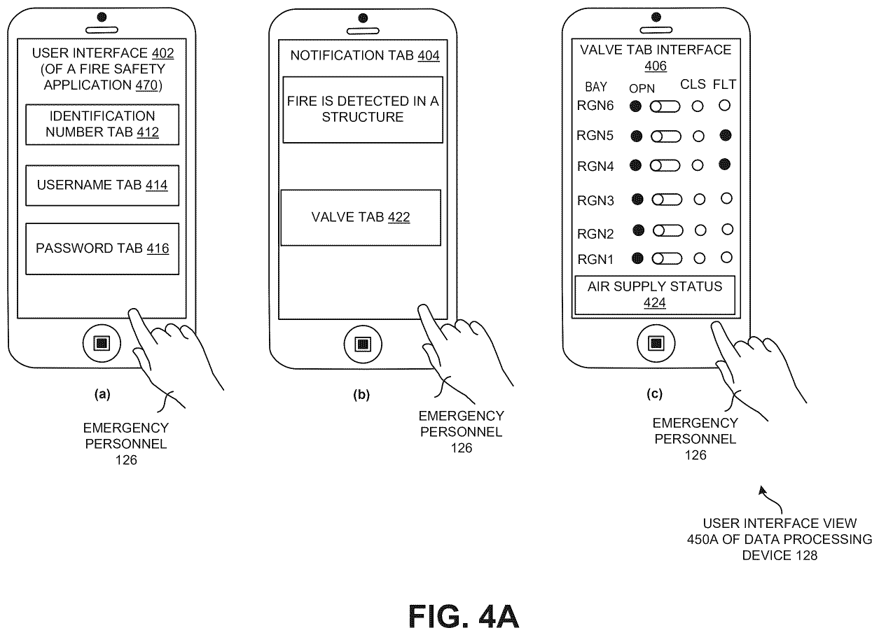

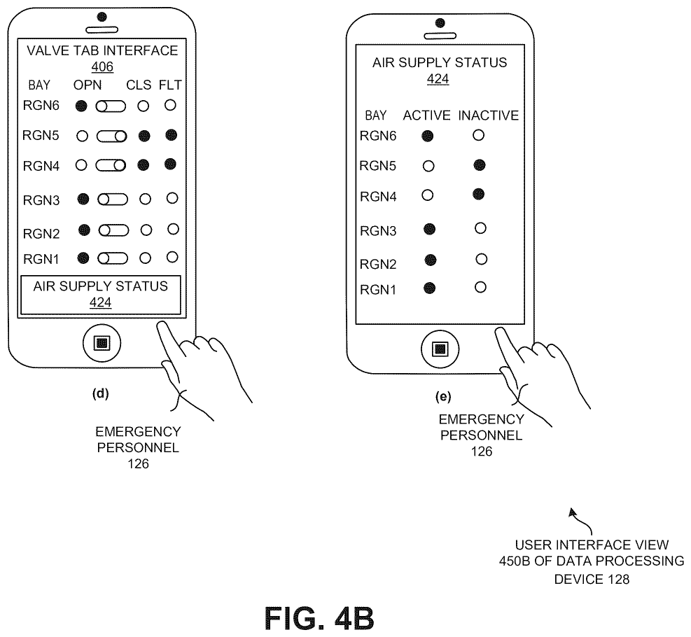

FIG. 4A shows an example user interface view 450A of data processing device 128 of safety system 150 of FIGS. 1 and 3. As shown in ‘(a)’, a user interface 402 of data processing device 128 may display user authentication tabs with respect to emergency personnel 126. For example, user interface 402 may display an identification number tab 412, a username tab 414 and a password tab 416. A user (e.g., emergency personnel 126) may need to enter an identification number, a username and/or a password in order to access a fire safety application 470 executing on data processing device 128.

In one or more embodiments, user interface 402 may help the user to navigate and view different parameters and contexts of safety system 150. As shown in ‘(b)’, the user may receive a pop-up alert notification in a notification tab 404. Notification tab 404 may indicate detection of a fire at an interior region 102 (e.g., compromised region 336) within structure 101. In accordance therewith, the user may click on a valve tab 422 to take necessary corrective measures. As shown in ‘(c)’, a valve tab interface 406 may indicate one or more interior regions 102 in which a faulty condition (FLT) has been detected. Control valve interface 406 may also indicate whether a valve 120_{1-P} is open (OPN) or closed (CLS) at a particular interior region 102. Further, valve tab interface 406 may enable the user to check air supply status 424 of the breathable air at a particular fill station 122_{1-P}. In FIG. 4A, valve tab interface 406 shows that all valves 120_{1-P} are open (OPN) and faults (FLT) have occurred in specific interior regions, viz. RGN4 and RGN5 (e.g., region 4 218 and region 5 220).

FIG. 4B is a continuation of FIG. 4A as user interface view 450B of data processing device 128. As shown in ‘(d)’, valve tab interface 406 now indicates closure (e.g., through the user via valve tab interface 406) of valves 120_{1-P} corresponding to RGN4 and RGN 5 in which faults have occurred. Thus, air fill stations 122_{1-P} in the above specific interior regions 102, viz. region 4 218 and region 5 220, may be isolated. Further, the user (e.g., emergency personnel 126) may click on air supply status 424 discussed above to check the status of the breathable air supply in the corresponding air fill stations 122_{1-P} of interior regions 102 of structure 101. As shown in ‘(e)’, air supply status 424 shows that RGN1 (e.g., region 1 212), RGN2 (e.g., region 2 214), RGN3 (e.g., region 3 216), and RGN6 (e.g., region 6 222) are active, which may imply that there is a continuous supply of breathable air to air fill stations 122_{1-P} of region 1 212, region 2 214, region 3 216 and region 6 222 (specific interior regions 102) of structure 101. Further, air supply status 424 shows that RGN4 (e.g., region 4 218) and RGN5 (e.g., region 5 220) are inactive, thereby indicating that air fill stations 122_{1-P} of region 4 218 and region 5 220 of structure 101 are isolated. All reasonable variations are within the scope of the exemplary embodiments discussed herein.

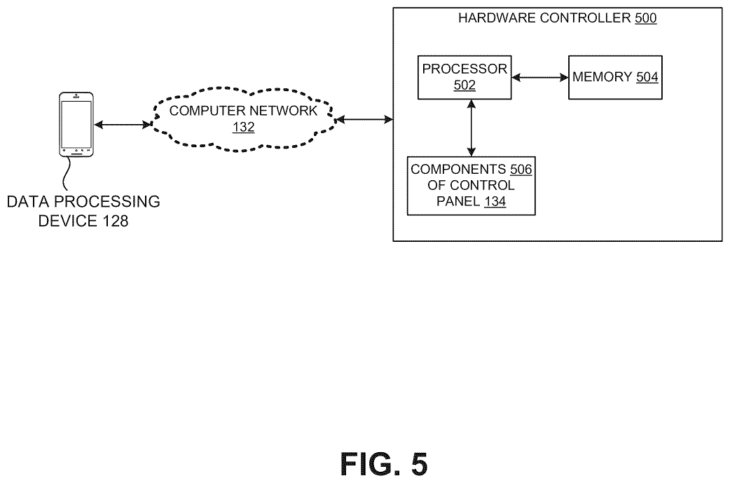

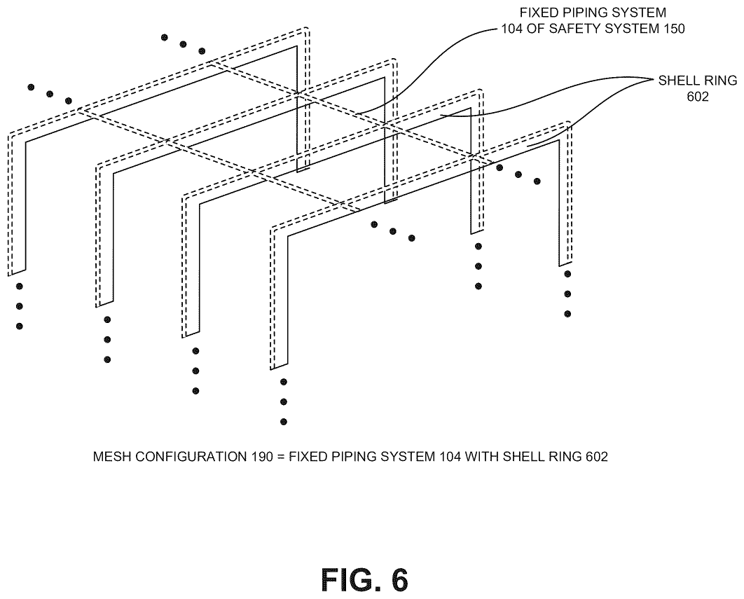

FIG. 5 shows a hardware controller 500, according to one or more embodiments. In one or more embodiments, hardware controller 500 may include a processor 502 (e.g., a microprocessor, a microcontroller, a processor core, a processor) communicatively coupled to a memory 504 (e.g., a non-volatile and/or a volatile memory). In one or more embodiments, all components 506 of control panel 134 may be communicatively coupled to processor 502; in some embodiments, processor 502 may transmit signals to control components 506 and receive signals therefrom. In some embodiments, hardware controller 500 may be the same as control panel 134. As shown in FIG. 5, hardware controller 500 may be communicatively coupled to data processing device 128 through computer network 132. All concepts associated with FIGS. 1-4A/B (and FIG. 6) may be applicable to hardware controller 500 of FIG. 5 and all variations therein are within the scope of the exemplary embodiments discussed herein. In the scenarios discussed above, hardware controller 500 and/or data processing device 128 may detect event 350 and, in accordance therewith, may cut off (e.g., automatically, manually) the breathable air to compromised first sub-portion 112 of first portion 108 of fixed piping system 104 based on controlling one or more valves 120_{1-P} associated with first sub-portion 112.

FIG. 6 shows fixed piping system 104 of FIG. 1 and FIG. 3 without other components of safety system 150, according to one or more embodiments. FIG. 6 serves to merely discuss concepts associated with a mesh configuration 190 of fixed piping system 104 shown in FIG. 1 and FIG. 3. In one or more embodiments, fixed piping system 104 and ringed air piping architecture 106 may involve a mesh configuration 190 thereof with interconnected pipes, criss-crossing elements and so on. In one or more embodiments, in accordance with detection of event 350 through control panel 134 and/or data processing device 128 and cutting off supply of breathable air to first sub-portion 112, mesh configuration 190 may involve first portion 108 and second portion 110 forming a continuous ring along with a shell ring 602, as shown in FIG. 6, such that shell ring 602 is below/beneath fixed piping system 104 and coupled/connected thereto. In one or more embodiments, the coupling of shell ring 602 to fixed piping system 104 may involve breathable air being continuously supplied to first portion 108 through shell ring 602 (also interpretable as second portion 110 of fixed piping system 104) during compromise to first sub-portion 112 of first portion 108 discussed above. Thus, as shown in FIG. 6, in one or more embodiments, mesh configuration 190/ringed air piping architecture 106 may be interpreted as fixed piping system 104 with shell ring 602.

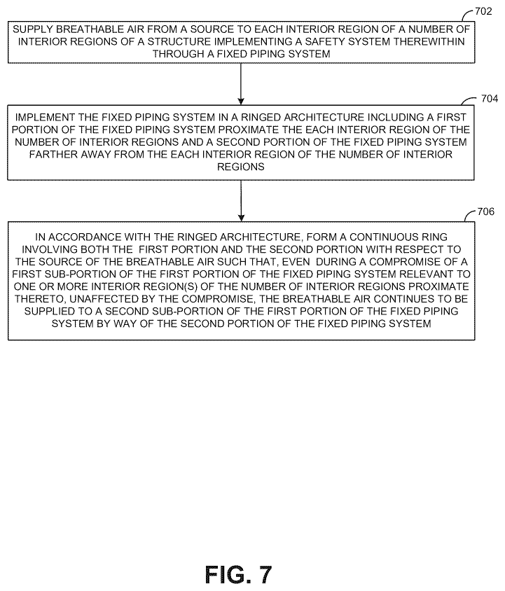

FIG. 7 shows a process flow diagram detailing the operations involved in a safety system (e.g., safety system 150) implemented with a ringed architecture (e.g., ringed air piping architecture 106) of a fixed piping system (e.g., fixed piping system 104) within a structure (e.g., structure 101) to continuously supply breathable air therewithin, according to one or more embodiments. In one or more embodiments, operation 702 may involve supplying breathable air from a source (e.g., air storage system 118, another air storage system 109) to each interior region of a number of interior regions (e.g., interior regions 102) of the structure through the fixed piping system. In one or more embodiments, operation 704 may involve implementing the fixed piping system in the ringed architecture including a first portion (e.g., first portion 108) of the fixed piping system proximate the each interior region of the number of interior regions and a second portion (e.g., second portion 110) of the fixed piping system farther away from the each interior region of the number of interior regions.

In one or more embodiments, operation 706 may then involve, in accordance with the ringed architecture, forming a continuous ring involving both the first portion and the second portion with respect to the source of the breathable air such that, even during a compromise of a first sub-portion (e.g., first sub-portion 112) of the first portion of the fixed piping system relevant to one or more interior region(s) of the number of interior regions proximate thereto, unaffected by the compromise, the breathable air continues to be supplied to a second sub-portion (e.g., second sub-portion 114) of the first portion of the fixed piping system by way of the second portion of the fixed piping system.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1.-20. (canceled)

21. A firefighter air replenishment system (FARS), comprising:
a source of breathable air;
a piping system, comprising:
a first portion coupled with the source of breathable air, the first portion comprising a first sub-portion and a second sub-portion; and
a second portion coupled with the source of breathable air, such that the first portion and the second portion form a ring architecture to allow for breathable air to flow from the source of breathable air to the second sub-portion through the first sub-portion or through the second portion; and
a plurality of air fill stations coupled with the piping system.

22. The FARS of claim 21, comprising:
the first portion and the second portion each comprise one or more pipes.

23. The FARS of claim 21, comprising:
the piping system is a fixed piping system.

24. The FARS of claim 21, comprising:
one or more valves coupled with the piping system and with the plurality of air fill stations to isolate at least one air fill station of the plurality of air fill stations.

25. The FARS of claim 21, comprising:
at least one valve between the first sub-portion and the second sub-portion to allow for isolation of the first sub-portion from the second sub-portion.

26. The FARS of claim 21, comprising:
the source of breathable air comprises a plurality of compressed air storage tanks.

27. The FARS of claim 21, comprising:
a valve between the first sub-portion and the second sub-portion; and
a controller to cause the valve to close to isolate the first sub-portion from the second sub-portion.

28. The FARS of claim 21, comprising:
a controller to:
detect a compromise of an interior region of a structure associated with the first sub-portion; and
control operation of one or more valves to allow for air to flow to the second sub-portion from the source of breathable air through the second portion and not through the first sub-portion.

29. The FARS of claim 21, comprising:
the ring architecture is a continuous ring architecture.

30. The FARS of claim 21, comprising:
the plurality of air fill stations comprises a first air fill station to be in an interior region of a structure;
the first portion is coupled with the first air fill station; and
the second portion is farther from the interior region than the first portion.

31. The FARS of claim 21, comprising:
the piping system comprises a shell ring of piping coupled with the first portion and the second portion.

32. The FARS of claim 21, comprising:
the piping system is in a structure comprising a shopping mall, a hypermart, an extended shopping facility, a storage center, a fulfillment center, a warehouse, a tunnel, a marine craft, or a mine.

33. A safety system, comprising:
a source of breathable air;
a piping system comprising a plurality of portions forming a ring;
at least one valve coupled with the plurality of portions;
at least one air fill station coupled with the at least one valve; and
a controller to control operation of the at least one valve to isolate a first sub-portion of a first portion of the plurality of portions from the at least one air fill station and to allow for the breathable air to flow from the source to the at least one air fill station through a second portion of the plurality of portions and a second sub-portion of the first portion.

34. The safety system of claim 33, comprising:
the piping system is a fixed piping system.

35. The safety system of claim 33, comprising:
a first valve of the at least one valve is between the first sub-portion and the second sub-portion;
and a second valve of the at least one valve is between the source of breathable air and the first portion.

36. The safety system of claim 33, comprising:
the source of breathable air comprises a plurality of compressed air storage tanks.

37. The safety system of claim 33, comprising:
the controller is to present a status of the at least one valve.

38. The safety system of claim 33, comprising:
the controller is to:
detect a compromise of an interior region of a structure associated with the first sub-portion; and
cause the at least one valve to isolate the first sub-portion from the at least one air fill station.

39. The safety system of claim 33, comprising:
the at least one air fill station is in an interior region of a structure; and
the second portion is farther from the interior region than the first portion.

40. The safety system of claim 33, comprising:
the piping system comprises one or more interconnection pipes to form a mesh structure of the ring.
